(19) United States
(12) Patent Application Publication
(10) Pub. No.: US 2013/0051356 A1
(43) Pub. Date: Feb. 28, 2013

(54) DEVICE AND METHOD FOR TRANSMITTING DOWNLINK CONTROL INFORMATION IN A WIRELESS COMMUNICATION SYSTEM

(71) Applicants: Sung Kwon Hong, Seoul (KR); Sung Jin Suh, Seoul (KR)

(72) Inventors: Sung Kwon Hong, Seoul (KR); Sung Jin Suh, Seoul (KR)

(73) Assignee: PANTECH CO., LTD., Seoul (KR)

(21) Appl. No.: 13/696,024

(22) PCT Filed: May 3, 2011
(86) PCT No.: PCT/KR11/03290

§ 371 Date: Nov. 2, 2012

(30) Foreign Application Priority Data
May 3, 2010 (KR) 10-2010-0041606
Aug. 6, 2010 (KR) 10-2010-0076121

(51) Int. Cl. H04W 72/04

(52) U.S. Cl. 370/329

(57) ABSTRACT

A device and method for transmitting downlink control information in a wireless communication system provides a method for transmitting downlink control information by a base station. The method comprises: configuring downlink control information comprising a resource allocation field displaying resource indicating values in a specific range; and transmitting the downlink control information to a terminal over a physical downlink control channel. Resource indicating values that are not being used in a resource allocation field can be utilized to configure new downlink control information and formats, or the same can be used in the transmission of new data such that it is possible to achieve compatibility with the control information and formats of existing systems, and a new control channel can be configured without a great increase in complexity.

### CROSS-REFERENCE TO RELATED APPLICATIONS

This application is the National Stage Entry of International Application No. PCT/KR2011/003290, filed on May 3, 2011 and claims priority from and the benefit of Korean Patent Application Nos. 10-2010-0041606, filed on May 3, 2010, and 10-2010-0076121, filed on Aug. 6, 2010, all of which are hereby incorporated by reference for all purposes as if fully set forth herein.

### BACKGROUND

1. Field

The present invention relates to wireless communication and, more specifically, to an apparatus and method for transmitting downlink control information in a wireless communication system.

2. Discussion of the Background

In general, a base station may know a downlink channel state when a user equipment informs the base station of a well-known control signal, such as a Channel Quality Indicator (CQI). A base station may receive a downlink channel state from each user equipment and perform frequency selective scheduling. However, in order to perform frequency selective scheduling in connection with an uplink channel, a base station needs to know an uplink channel state.

An uplink reference signal is a signal known both to a base station and a user equipment and is also called a pilot. The uplink reference signal includes a demodulation reference signal and a Sounding Reference Signal (SRS). The demodulation reference signal is used in channel estimation for data demodulation, and the SRS is used in user scheduling of uplink. A user equipment sends an SRS through an uplink channel, and a base station checks a channel state of uplink from the SRS and performs uplink scheduling.

Meanwhile, not only an SRS, but also data or various pieces of uplink control information are transmitted through an uplink control channel. An uplink control signal includes various types, such as acknowledgement (ACK)/not-acknowledgement (Non-ACK) signals for performing a Hybrid Automatic Repeat request (HARQ), a Channel Quality Indicator (CQI) indicative of the quality of a downlink channel, a Precoding Matrix Index (PMI), and a Rand Indicator (RI).

FIG. 1 is an example of the structure of an uplink subframe that transmits an SRS.

Referring to FIG. 1, the uplink subframe includes two slots on the time axis, and each of the slots includes 7 Single Carrier-Frequency Division Multiple Access (SC-FDMA) symbols. The uplink subframe includes a Physical Uplink Control Channel (PUCCH) and a Physical Uplink Shared Channel (PUSCH) on the frequency axis. A PUCCH in the SC-FDMA symbol period in which an SRS is transmitted is punctured. Here, a user equipment transmits data using 13 SC-FDMA symbols and transmits an SRS in relation to the remaining last one SC-FDMA symbol using a pre-processing process, such as rate matching. It has been determined that a 14^{th} SC-FDMA symbol sends an SRS, but this is only illustrative. The positions and number of SF-FDMA symbols may be differently determined. An SRS may be transmitted in all PUSCHs or may be transmitted in only some of the PUSCHs.

As one new method that is taken into consideration in LTE-Advanced (A), there is an aperiodic SRS (A-SRS). In the A-SRS, a user equipment can transmit an SRS aperiodically, so that resources can be used efficiently as compared with the case where an SRS is transmitted periodically. In relation to the transmission of an A-SRS, a base station has to indicate to a user equipment that an SRS will be transmitted or has to inform the user equipment of information related to the transmission of the SRS.

Although an A-SRS has been taken as a specific example, downlink control information must be added in order to handle a new procedure or new information that is required according to the appearance of a new system. To this end, a format that is compatible with the existing system must be maintained, but the addition of a new field must be taken into account. However, the format of the downlink control information of the existing LTE is very limited, and there is less room for adding a new field. Although a new field is added, there is a problem in that a load on the blind decoding of a user equipment is added. Accordingly, there is a need for an apparatus and method for transmitting downlink control information, which are capable of minimizing a change in the structure of the existing system and are compatible with the existing system although new downlink control information to be applied to a new system is added.

### SUMMARY

An object of the present invention is to provide an apparatus and method for transmitting downlink control information in a wireless communication system.

Another object of the present invention is to provide a method of configuring a new control channel for uplink scheduling information in a wireless communication system.

Yet another object of the present invention is to provide a method of transmitting an uplink signal in a wireless communication system.

Still yet another object of the present invention is to provide a method of configuring resource allocation information for non-contiguous resource allocation in a wireless communication system.

In accordance with an aspect of the present invention, there is provided a method of a base station transmitting downlink control information. The method includes the steps of configuring the downlink control information including a resource allocation field indicating the Resource Indication Value (RIV) of a specific range, and transmitting the downlink control information to a user equipment on a physical downlink control channel (PDCCH).

The RIV of the specific range may indicate that the downlink control information includes configuration information for the transmission of an uplink signal.

In accordance with another aspect of the present invention, there is provided a method of a user equipment receiving downlink control information. The method includes the steps of receiving the downlink control information including a resource allocation field indicative of the RIV of a specific range, from a base station on a PDCCH, analyzing the format of the downlink control information based on the RIV of the specific range, and decoding the downlink control information according to the analyzed format.

In accordance with yet another aspect of the present invention, there is provided an apparatus for transmitting downlink control information. The apparatus includes a downlink control information configuration unit for configuring the downlink control information based on the RIV of a specific range that is represented by a resource allocation field, a control channel configuration unit for configuring a PDCCH on which the downlink control information will be transmitted, and a control channel transmission unit for transmitting the downlink control information to a user equipment on the PDCCH.

The downlink control information may include information indicative of the transmission of an uplink signal by the user equipment.

In accordance with still yet another aspect of the present invention, there is provided an apparatus for receiving downlink control information. The apparatus includes a control channel reception unit for receiving the downlink control information from a base station on a PDCCH, a control channel decoding unit for extracting the downlink control information by performing blind decoding on the control channel, and a downlink control information analysis unit for separating a resource allocation field from a plurality of fields included in the downlink control information, checking the format of the downlink control information using an RIV indicated by the resource allocation field, and analyzing the downlink control information using an analysis method suitable for the checked format.

In accordance with still yet another aspect of the present invention, there is provided a method of transmitting downlink control information. The method includes the steps of configuring information about an uplink signal or information about a downlink signal using a specific range selected from the total range of an RIV that is represented by a resource allocation field, transmitting downlink control information including the information about the uplink signal or the information about the downlink signal to a user equipment, and receiving the uplink signal from the user equipment based on the information about the uplink signal or transmitting the downlink signal to the user equipment based on the information about the downlink signal.

The information about the uplink signal is resource allocation information indicative of the allocation of resource blocks for the transmission of the uplink signal, and the selected specific range may indicate the resource blocks that are allocated according to a non-contiguous allocation method.

The step of configuring the information about the uplink signal or the information about the downlink signal includes configuring the information about the uplink signal or the information about the downlink signal using the selected specific range and a redundant bit included in the downlink control information.

The step of configuring the information about the uplink signal or the information about the downlink signal may include configuring the information about the uplink signal or the information about the downlink signal using the selected specific range, a redundant bit included in the downlink control information, and an adaptive field a user of which is variably set depending on the redundant bit.

If the redundant bit indicates that the allocation of the resource blocks for the transmission of the uplink signal is contiguously performed, the adaptive field may indicate whether frequency hopping is applied to the uplink transmission or not.

If the redundant bit indicates that the allocation of the resource blocks for the transmission of the uplink signal is non-contiguously performed, the adaptive field and the resource allocation field may represent the RIV.

The information about the uplink signal is resource allocation information indicative of the allocation of resource block groups for the transmission of the uplink signal, and the selected specific range may indicate resource blocks that are allocated according to a non-contiguous allocation method.

The information about the uplink signal is resource allocation information indicative of resource blocks that are allocated for the transmission of the uplink signal, the allocated resource blocks are divided into a resource block of a first part and a resource block of a second part, a non-contiguous allocation method may be applied to the resource block of the first part, and a contiguous allocation method may be applied to the resource block of the second part.

The resource block of the first part may be a specific number of resource blocks that form the start part and the end part of the allocated resource block, and the resource block of the second part may be the remaining resource blocks other than a specific number of the resource blocks that form the start part and the end part in the allocated resource blocks.

The information about the uplink signal is resource allocation information indicative of resource block groups allocated for the transmission of the uplink signal, the allocated resource block groups are divided into a resource block group of a first part group and a resource block group of a second part, a non-contiguous allocation method may be applied to the resource block group of the first part, and a contiguous allocation method may be applied to the resource block group of the second part.

The resource block group of the first part may be a specific number of resource block groups that form the start part and the end part of the allocated resource block group, and the resource block group of the second part may be the remaining resource block groups other than a specific number of the resource block groups that form the start part and the end part in the allocated resource block groups.

The information about the uplink signal is resource allocation information indicative of the allocation of resource blocks for the transmission of the uplink signal, and the selected specific range may indicate resource blocks that are allocated according to a non-contiguous allocation method.

The step of configuring the information about the uplink signal may include configuring the information about the uplink signal using the selected specific range and a redundant bit included in the downlink control information.

The step of configuring the information about the uplink signal may include configuring the information about the uplink signal using the selected specific range, the redundant bit included in the downlink control information, and an adaptive field a use of which is variably set depending on the redundant bit.

If the redundant bit indicates that the allocation of the resource blocks for the transmission of the uplink signal is contiguously performed, the adaptive field may indicate whether frequency hopping is applied to the uplink transmission or not.

If the redundant bit indicates that the allocation of the resource blocks for the transmission of the uplink signal is non-contiguously performed, the adaptive field and the resource allocation field may represent the RIV.

The information about the uplink signal is resource allocation information indicative of the allocation of resource block groups for the transmission of the uplink signal, and the selected specific range may indicate resource blocks that are allocated according to a non-contiguous allocation method.

The information about the uplink signal is resource allocation information indicative of resource blocks that are allocated for the transmission of the uplink signal, the allocated resource blocks are divided into a resource block of a first part and a resource block of a second part, a non-contiguous allocation method may be applied to the resource block of the first part, and a contiguous allocation method may be applied to the resource block of the second part.

The resource block of the first part may be a specific number of resource blocks that form the start part and the end part of the allocated resource block, and the resource block of the second part may be the remaining resource blocks other than a specific number of the resource blocks that form the start part and the end part in the allocated resource blocks.

The information about the uplink signal is resource allocation information indicative of resource block groups allocated for the transmission of the uplink signal, the allocated resource block groups are divided into a resource block group of a first part group and a resource block group of a second part, a non-contiguous allocation method may be applied to the resource block group of the first part, and a contiguous allocation method may be applied to the resource block group of the second part.

The resource block group of the first part may be a specific number of resource block groups that form the start part and the end part of the allocated resource block group, and the resource block group of the second part may be the remaining resource block groups other than a specific number of the resource block groups that form the start part and the end part in the allocated resource block groups.

In accordance with still yet another aspect of the present invention, there is provided a method of receiving downlink control information. The method includes the steps of receiving downlink control information including information about an uplink signal from a base station and transmitting the uplink signal to the base station based on the information about the uplink signal. The information about the uplink signal is configured using a specific range selected from an RIV that is represented by a resource allocation field.

In accordance with still yet another aspect of the present invention, there is provided an apparatus for transmitting downlink control information. The apparatus includes a downlink control information configuration unit for configuring the fields of downlink control information using a specific range selected from an RIV that is represented by a resource allocation field, a control channel configuration unit for configuring a control channel on which the downlink control information according to the configured fields will be transmitted, and a transmission unit for transmitting the downlink control information to a user equipment through the control channel. The downlink control information includes information indicative of the transmission of an uplink signal by the user equipment.

In accordance with still yet another aspect of the present invention, there is provided an apparatus for transmitting downlink control information. The apparatus includes a downlink control information configuration unit for configuring the fields of downlink control information using a specific range selected from an RIV that is represented by a resource allocation field, a control channel configuration unit for configuring a control channel on which the downlink control information according to the configured fields will be transmitted, and a control channel transmission unit for transmitting the downlink control information to a user equipment through the control channel. The downlink control information includes information indicative of the transmission of an uplink signal by the user equipment.

The format of new downlink control information is configured using a RIV that is not used in a resource allocation field, or the RIV is used to transmit new information. The format of the new downlink control information is compatible with the format of control information of the existing system, and a new control channel can be configured without a great increase of complexity.

### BRIEF DESCRIPTION OF THE DRAWINGS

FIG. 1 is an example of the structure of an uplink subframe that transmits an SRS.

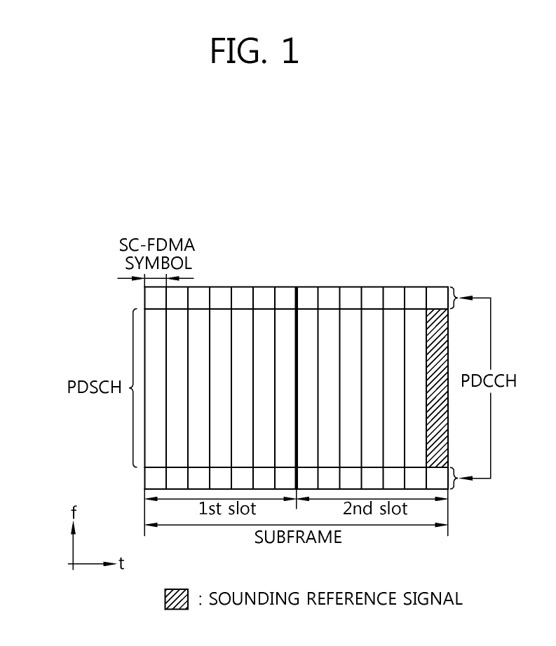

FIG. 2 shows a wireless communication system to which the present invention is applied.

FIG. 3 shows the structure of a radio frame to which the present invention is applied.

FIG. 4 shows the structure of a downlink subframe to which the present invention is applied.

FIG. 5 is an exemplary diagram showing a resource grid for one downlink slot to which the present invention is applied.

FIG. 6 is an example of a resource allocation method to which the present invention is applied. This is a resource allocation method of Type 0.

FIG. 7 is another example of a resource allocation method to which the present invention is applied.

FIG. 8 is yet another example of a resource allocation method to which the present invention is applied.

FIG. 9 is a block diagram illustrating a DCI transmission apparatus and a DCI reception apparatus in accordance with an example of the present invention.

FIG. 10 is a flowchart illustrating a method of transmitting DCI in accordance with an example of the present invention.

FIG. 11 is a flowchart illustrating a method of a base station transmitting DCI in accordance with an example of the present invention.

FIG. 12 is a flowchart illustrating a method of a user equipment receiving DCI in accordance with an example of the present invention.

### DETAILED DESCRIPTION OF THE ILLUSTRATED EMBODIMENTS

Hereinafter, in this specification, some embodiments are described in detail with reference to exemplary drawings. It is to be noted that in assigning reference numerals to elements in each of the drawings, the same reference numerals designate the same elements throughout the drawings although the elements are shown in different drawings. Furthermore, in describing the embodiments of the present invention, a detailed description of the known functions and constructions will be omitted if it is deemed to make the gist of the present invention unnecessarily vague.

Furthermore, in describing the elements of this specification, terms, such as the first, second, A, B, (a), and (b), may be used. However, the terms are used to only distinguish one element from the other element, but the essence, order, or sequence of the elements is not limited by the terms. When it is said that one element is “connected”, “combined”, or “coupled” with the other element, the one element may be directly connected or coupled with the other element, but it should be understood that a third element may be “connected”, “combined”, or “coupled” between the two elements.

Furthermore, in this specification, a wireless communication network is described as a target, and tasks performed in the wireless communication network may be performed in a process in which a system (e.g., a base station) managing the wireless communication network controls the wireless communication network and sends data or may be performed in a terminal accessing the wireless communication network.

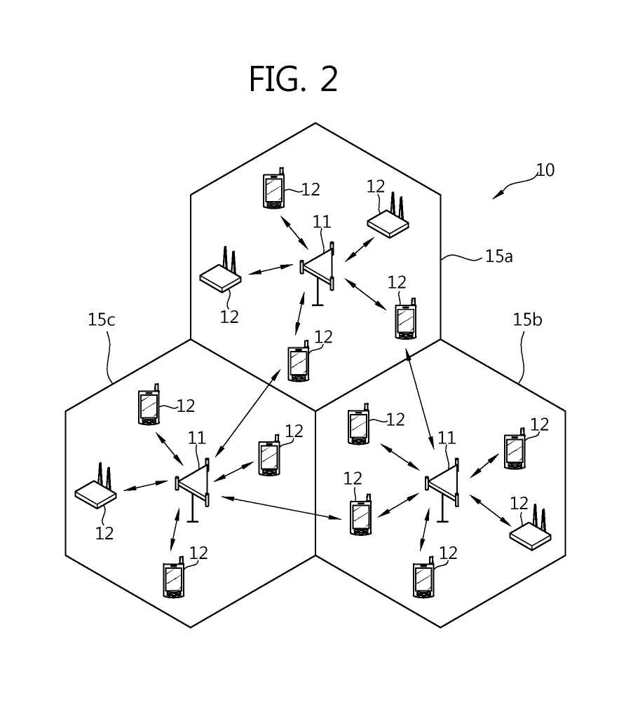

FIG. 2 shows a wireless communication system to which the present invention is applied.

Referring to FIG. 2, the wireless communication systems 10 are widely deployed in order to provide a variety of communication services, such as voice and packet data. The wireless communication system 10 includes one or more Base Stations (BS) 11. The BSs 11 provide communication services to specific geographical areas (commonly called cells) 15a, 15b, and 15c. Each of the cells may be classified into a plurality of areas (called sectors).

A User Equipment (UE) 12 may be fixed or mobile and may be also called another terminology, such as Mobile Station (MS), a Mobile Terminal (MT), a User Terminal (UT), a Subscriber Station (SS), a wireless device, a Personal Digital Assistant (PDA), a wireless modem, or a handheld device. The BS 11 refers to a fixed station communicating with the UEs 12, and it may also be called another terminology, such as an evolved NodeB (eNB), a Base Transceiver System (BTS), or an access point. The cell should be interpreted as a comprehensive meaning that indicates some area covered by the BS 11. The cell has a meaning to cover various coverage areas, such as a mega cell, a macro cell, a micro cell, a pico cell, and a femto cell.

Hereinafter, downlink refers to communication or a communication path from the BS 11 to the UE 12, and uplink refers to communication or a communication path from the UE 12 to the BS 11. In downlink, a transmitter may be part of the BS 11, and a receiver may be part of the UE 12. In uplink, a transmitter may be part of the UE 12, and a receiver may be part of the BS 11. Multiple access schemes applied to the wireless communication system are not limited. A variety of multiple access schemes, such as Code Division Multiple Access (CDMA), Time Division Multiple Access (TDMA), Frequency Division Multiple Access (FDMA), Orthogonal Frequency Division Multiple Access (OFDMA), Single Carrier Frequency Division Multiple Access (SC-FDMA), OFDM-FDMA, OFDM-TDMA, and OFDM-CDMA, may be used. Uplink transmission and downlink transmission may be performed in accordance with a Time Division Duplex (TDD) scheme using different times or a Frequency Division Duplex (FDD) scheme using different frequencies.

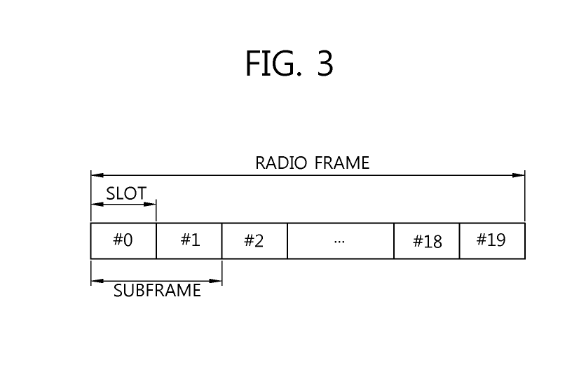

FIG. 3 shows the structure of a radio frame to which the present invention is applied.

Referring to FIG. 3, the radio frame includes 10 subframes, and one subframe includes two slots. The time taken for one subframe to be transmitted is called a Transmission Time Interval (TTI). For example, the length of one subframe may be 1 ms, and the length of one slot may be 0.5 ms.

One slot includes a plurality of Orthogonal Frequency Division Multiplexing (OFDM) symbols in the time domain and includes a plurality of Resource Blocks (RBs) in the frequency domain. An OFDM symbol is for representing one symbol period because downlink OFDMA is used in 3GPP LTE and may be called an SC-FDMA symbol or a symbol period depending on a multi-access scheme. An RB is a resource allocation unit, and it includes a plurality of contiguous subcarriers in one slot.

The structure of the radio frame is only illustrative, and the number of subframes included in a radio frame or the number of slots included in a subframe and the number of OFDM symbols included in a slot may be changed in various ways.

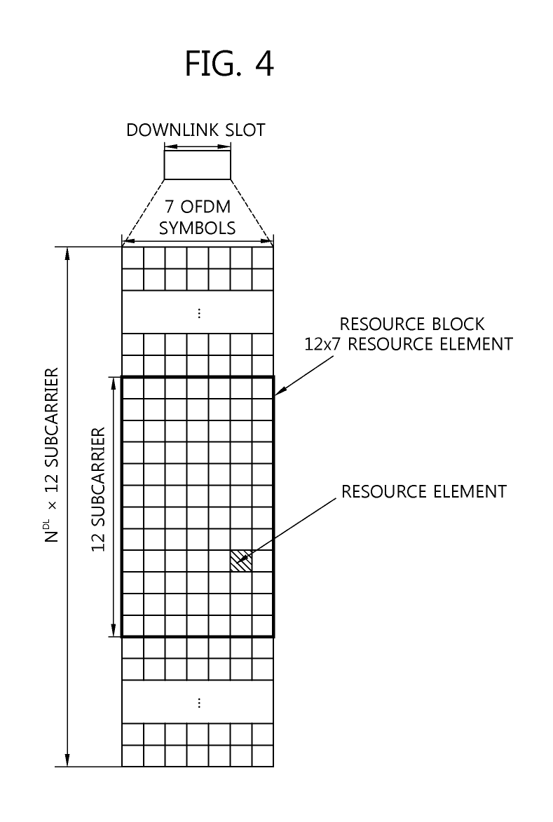

FIG. 4 shows the structure of a downlink subframe to which the present invention is applied.

Referring to FIG. 4, the subframe includes two slots. The former 2 or 3 OFDM symbols of the first slot within the subframe correspond to a control region to which a Physical Downlink Control Channel (PDCCH) is allocated, and the remaining OFDM symbols thereof become a data region to which a Physical Downlink Shared Channel (PDSCH) is allocated.

Downlink control channels include a Physical Control Format Indicator Channel (PCFICH), a Physical Downlink Control Channel (PDCCH), and a Physical Hybrid-ARQ Indicator Channel (PHICH). The PCFICH is transmitted in the first OFDM symbol of a subframe, and it carries information about the number of OFDM symbols (i.e., the size of a control region) that are used to transmit control channels within the subframe. The PHICH carries acknowledgement (ACK)/not-acknowledgement (NACK) signals in response to an uplink Hybrid Automatic Repeat Request (HARQ). That is, ACK/NACK signals for uplink data that has been transmitted by a UE are transmitted on a PHICH.

A PDCCH, that is, a downlink physical channel, is described below.

A PDCCH can carry information about the resource allocation and transmission format of a Downlink Shared Channel (DL-SCH), information about the resource allocation of an Uplink Shared Channel (UL-SCH), paging information about a Paging Channel (PCH), system information on a DL-SCH, information about the resource allocation of a higher layer control message, such as a random access response transmitted on a PDSCH, a set of transmit power control commands for UEs within a certain UE group, the activation of a Voice over Internet Protocol (VoIP), etc. A plurality of PDCCHs may be transmitted within the control region, and a UE can monitor a plurality of PDCCHs. PDCCHs are transmitted on one Control Channel Element (CCE) or on an aggregation of some contiguous CCEs. A CCE is a logical assignment unit for providing a coding rate according to the state of a radio channel to a PDCCH. A CCE corresponds to a plurality of resource element groups. The format of a PDCCH and the number of possible bits of a PDCCH are determined by a correlation between the number of CCEs and a coding rate provided by CCEs.

Control information transmitted through a PDCCH is called Downlink Control Information (hereinafter referred to as DCI). The DCI is differently used depending on its format, and it also has a different field that is defined within the DCI. Table 1 shows DCI according to a DCI format.

TABLE 1

| DCI FORMAT | DESCRIPTION |
|---|---|
| 0 | Used for the scheduling of a PUSCH (uplink grant) |
| 1 | Used for the scheduling of one PDSCH codeword |
| 1A | Used for the simplified scheduling of one PDSCH |
| | codeword and for a random access procedure |
| | reset by a PDCCH command |
| 1B | Used for the simplified scheduling of one PDSCH |
| | codeword using precoding information |
| 1C | Used for the simplified scheduling of one PDSCH |
| | codeword and the notification of a |
| | change of an MCCH |
| 1D | Used for precoding and the simplified scheduling of |
| | one PDSCH codeword including power |
| | offset information |
| 2 | Used for PDSCH scheduling for a UE configured in |
| | spatial multiplexing mode |
| 2A | Used for the PDSCH scheduling of a UE configured |
| | in large delay CDD mode |
| 3 | Used for the transmission of a TPC command for a |
| | PUCCH and PUSCH including 2-bit power |
| | coordination |
| 3A | Used for the transmission of a TPC command for a |
| | PUCCH and PUSCH including single bit |
| | power coordination |

The DCI Format 0 indicates uplink resource allocation information, the DCI formats 1˜2 indicate downlink resource allocation information, and the DCI formats 3 and 3A indicate uplink Transmit Power Control (TPC) commands for specific UE groups. The fields of the DCI are sequentially mapped to an information bit. For example, assuming that DCI is mapped to an information bit having a length of a total of 44 bits, a resource allocation field may be mapped to a 10^{th} bit to 23^{rd} bit of the information bit.

DCI includes uplink resource allocation information and downlink resource allocation information. The uplink resource allocation information may be called an uplink grant, and the downlink resource allocation information may be called a downlink grant.

Table 2 shows the DCI of Format 0, that is, uplink resource allocation information (or an uplink grant).

TABLE 2
Carrier indicator - 0 or 3 bits
Flag for identifying Format 0/Format 1A—1 bit, 0 indicates Format 0, 1 indicates Format
1A.
Frequency hopping flag—1 bit, is a Most Significant Bit (MSB) corresponding to resource
allocation at need and used to assign multiple clusters.
Resource block assignment and hopping resource allocation—|log₂(N_{RB}^{UL}( N_{RB}^{UL} + 1)/2)|
bits
PUSCH hopping (corresponding to only single cluster assignment):
N_{uL}_hop MSBs are used to obtain an ñ_{pRB} (i) value.
(|log₂ (N_{RB}^{UL}(N_{RB}^{UL} +1)/2)|−N_{UL}_hop) bits provide the resource allocation of the first slot
of an uplink subframe.
In single cluster assignment, non-hopping PUSCH
(|log₂ (N_{RB}^{UL}(N_{RB}^{UL} + 1)/2) bits provide the resource allocation of an uplink subframe.
In multi-cluster assignment, non-hopping PUSCH: Resource assignment is obtained from
a combination of a frequency hopping flag field and a resource block assignment and
hopping resource allocation field.
$⌈ {log}_{2} ( ( \frac{⌈ {N}_{RB}^{UL} / p + 1 ⌉}{4} ) ) ⌉$
bits provide resource allocation in an uplink subframe.
Wherein, P depends on the number of downlink resource blocks.
Modulation and coding scheme/redundancy version—5 bits
New data indicator—1 bit
TPC command for a scheduled PUSCH—2 bits
Cyclic shift and OCC index for DM RS—3 bits
Uplink index—2 bits, only exist for a TDD operation, that is, an uplink-downlink
configuration 0
Downlink Assignment Index (DAI)—2 bits, only exist for TDD operations, that is, uplink-
downlink configurations 1-6
CQI request—1 or 2 bits, a 2 bit field is applied to a UE configured using at least one
downlink cell.
SRS request—0 or 1 bit.
Multi-cluster flag—1bit.

The flag is 1-bit information and is an indicator for distinguishing the DCI 0 and the DCI 1A from each other. The hopping flag is 1-bit information, and it indicates whether frequency hopping is applied or not when a UE performs uplink transmission. For example, when the hopping flag is 1, it indicates that frequency hopping is applied at the time of uplink transmission. When the hopping flag is 0, it indicates that frequency hopping is not applied at the time of uplink transmission.

The resource block assignment and hopping resource allocation is also called a resource allocation field. The resource allocation field indicates the physical locations and amount of resources that are allocated to a UE. Although not shown in Table 2, an uplink grant includes redundant bits or padding bits for constantly maintaining the total number of bits. The DCI has several formats. Although DCI has control information of a different format, the length of bits can be identically controlled using the redundant bits. Thus, a UE can perform blind decoding smoothly.

For example, in Table 2, if the resource allocation field has 13 bits in a band of an FDD 20 MHz, an uplink grant has a total of 27 bits (except a CIF field and a CRC field). If the length of bits determined as the input of blind decoding is 28 bits, a BS makes the uplink grant the total number of 28 bits by adding the redundant bits of 1 bit to the uplink grant at the time of scheduling. Here, all the redundant bits may be set to 0 because they do not include special information. Of course, the number of redundant bits may be smaller than or greater than 2.

In relation to resource allocation, a physical resource structure is first described.

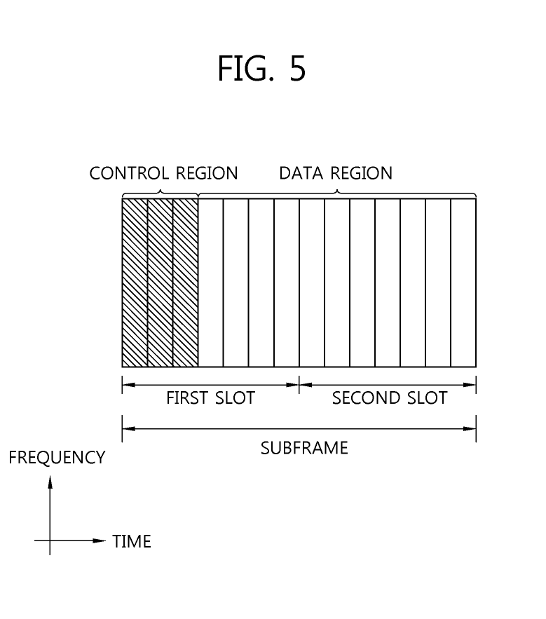

FIG. 5 is an exemplary diagram showing a resource grid for one downlink slot to which the present invention is applied.

Referring to FIG. 5, the downlink slot includes a plurality of OFDM symbols in the time domain. Here, one downlink slot is illustrated as including 7 OFDMA symbols and one Resource Block (RB) is illustrated as including 12 subcarriers in the frequency domain, but not limited thereto.

Each element on the resource grid is called a Resource Element (RE). One resource block includes 12×7 REs. The number N^{DL} of resource blocks included in a downlink slot depends on a downlink transmission bandwidth that is set in a cell. Bandwidths that are taken into account in LTE are 1.4 MHz, 3 MHz, 5 MHz, 10 MHz, 15 MHz, and 20 MHz. If the bandwidths are represented by the number of resource blocks, they are 6, 15, 25, 50, 75, and 100, respectively. One or more resource blocks corresponding to each band may be combined to form a Resource Block Group (RBG). For example, two contiguous resource blocks may form one resource block group.

In LTE, the total number of resource blocks for each bandwidth and the number of resource blocks that form one resource block group are shown in Table 3.

TABLE 3

| | Total number of | Number of RBs | Total number of |
|---|---|---|---|
| Bandwidth | RBs | belonging to one RBG | RBGs |
| 1.4 MHz | 6 | 1 | 6 |
| 3 MHz | 15 | 2 | 8 |
| 5 MHz | 25 | 2 | 13 |
| 10 MHz | 50 | 3 | 17 |
| 15 MHz | 75 | 4 | 19 |
| 20 MHz | 100 | 4 | 25 |

Referring to Table 3, the total number of available resource blocks is different depending on a given bandwidth. What the total number of resource blocks differs means that the size of information indicative of resource allocation is different. In addition, the number of cases in which resource blocks are allocated may be different depending on a resource allocation method. As an example of the resource allocation method, a resource block may be allocated using a bitmap form (Type 0). As another example of the resource allocation method, a resource block may be allocated at a specific interval or period (Type 1). As yet another example of the resource allocation method, a resource block may be allocated as a region having a continuous length (Type 2). A resource allocation field indicates resource block allocated to a UE, and the amount of bits required for the resource allocation field is different depending on the resource allocation method of each type and the total number of resource blocks for each bandwidth.

The resource allocation method of each type is described below. In the following description, a description of a resource block may be replaced with a resource block group.

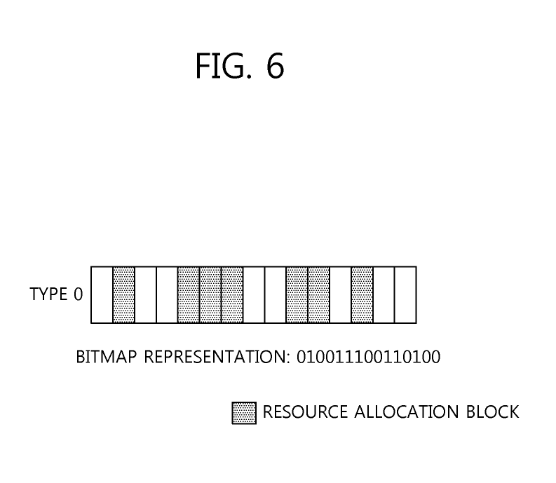

FIG. 6 is an example of a resource allocation method to which the present invention is applied. This is the resource allocation method of Type 0.

Referring to FIG. 6, the resource allocation method of Type 0 is a method of assigning all the resource blocks of a system to a UE in a cluster unit in which one or more contiguous resource blocks are combined. The clusters are spaced apart from each other by at least one resource block. This is also called non-contiguous resource allocation. In FIG. 6, a total of four clusters are allocated to a UE. The first cluster includes one resource block, the second cluster includes three resource blocks, the third cluster includes two resource block, and the fourth cluster includes one resource block. In particular, resource allocation in which two clusters are allocated to one UE is called a double cluster, and resource allocation in which three or more clusters are allocated to one UE is called unlimited non-contiguous resource allocation. The throughput of a system may differ depending on how many clusters are allocated.

The allocation or non-allocation of each resource block can be represented by a bitmap. Each bit is mapped to each resource block. For example, when a bit is 1, it means that a corresponding resource block is allocated to a UE. When a bit is 0, it means that a corresponding resource block is not allocated to a UE. For example, FIG. 6 shows a case where a bitmap is 010011100110100. If resource allocation for a UE is represented in the form of a bitmap as in Type 0, the number of necessary bits is equal to the number of resource blocks. That is, the number of necessary bits becomes

$$⌈ \frac{n}{P} ⌉$$

when the number of resource blocks is n. Here, ┌x┐ is a minimum integer that is greater than or equal to x.

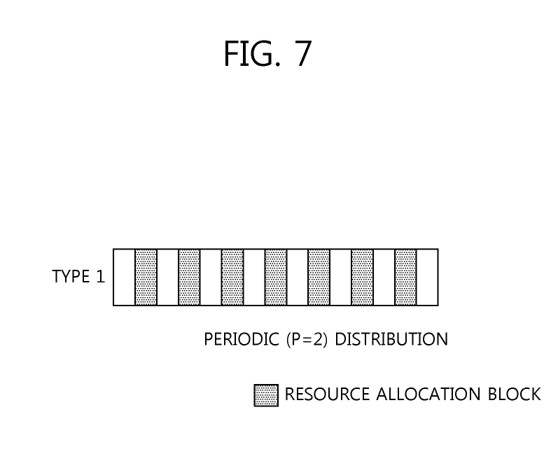

FIG. 7 is another example of the resource allocation method to which the present invention is applied. This is the resource allocation method of Type 1.

Referring to FIG. 7, resource blocks are allocated in a periodic form. The period has a period of P, and resource allocation may be represented in a form in which all resource blocks are distributed at a specific interval. For example, FIG. 7 is the case where the period P=2. The number of bits that are necessary to represent the resource allocation method of Type 1 is

$$⌈ \frac{n}{P} ⌉ + ⌈ {log}_{2} P ⌉ - 1.$$

Here, ┌log₂ P┐ is the size of a resource block subset that has the period P, and 1 is an offset. Thus, resource allocation of a special case can be represented. In general, if Type 0 and Type 1 are used together, a differentiation bit for distinguishing Type 0 and Type 1 from each other may be used.

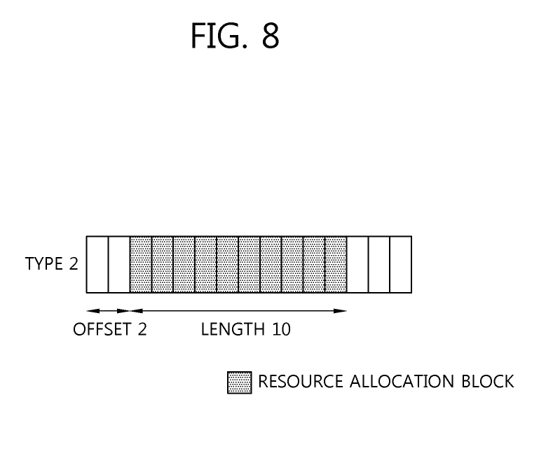

FIG. 8 is yet another example of a resource allocation method to which the present invention is applied. This is a resource allocation method of Type 2.

Referring to FIG. 8, one or more contiguous resource blocks may be combined and allocated. This is represented by an offset at the start point of all resource blocks, that is, the number of contiguous resource blocks. For example, FIG. 8 is the case where an offset is 2 and the number of resource blocks is 10. Type 0 and Type 1 represent non-contiguous resource allocation, whereas Type 2 represents contiguous resource allocation. Accordingly, if the number of resource blocks is many, the number of bits of the resource allocation field that are necessary to represent the resource allocation of Type 2 is smaller than Type 0 or Type 1. If n resource blocks are allocated according to Type 2, the number of all the cases of resource allocation is determined by Equation 1.

$${}_{n + 1}^{}{C}{}_{2}^{} = \frac{n ( n + 1 )}{2} \qquad Equation 1$$

Accordingly, the number of necessary bits of the resource allocation field is determined by Equation 2.

$$⌈ {log}_{2} ( \frac{n ( n + 1 )}{2} ) ⌉ \qquad Equation 2$$

The resource allocation field included in the uplink grant has to be able to represent both contiguous resource allocation and non-contiguous resource allocation. However, the number of bits of the resource allocation field has a limit to representing the number of all the cases according to contiguous resource allocation and non-contiguous resource allocation. Thus, the number of bits of the resource allocation field has to be increased. To increase the number of bits of the resource allocation field results in a change in the structure of the uplink grant. This may be inefficient because a load on the blind decoding of a UE is added. Accordingly, if the redundant bits that are included in DCI, but are not used are used in resource allocation, a conventional uplink grant structure can be maintained without change and limited resources can be efficiently used.

A resource allocation field that selectively represents contiguous resource allocation and non-contiguous resource allocation is hereinafter called a hybrid resource allocation field. The hybrid resource allocation field may indicate contiguous resource allocation and may indicate non-contiguous resource allocation. Whether the hybrid resource allocation field indicates contiguous resource allocation or non-contiguous resource allocation is indicated by a redundant bit.

For example, it is assumed that a redundant bit is 1 bit. If the redundant bit is 0, the hybrid resource allocation field included in the uplink grant may indicate contiguous resource allocation or non-contiguous resource allocation. If the redundant bit is 1, the hybrid resource allocation field may indicate non-contiguous resource allocation. That is, whether one hybrid resource allocation field indicates contiguous or non-contiguous resource allocation is determined by the redundant bit. For example, it is assumed that the resource allocation field has 4 bits, which has a value of 0001. If the redundant bit is 0, the value 0001 of the hybrid resource allocation field indicates one case of contiguous or non-contiguous resource allocation. In contrast, if the redundant bit is 1, the value 0001 of the hybrid resource allocation field indicates one case of non-contiguous resource allocation. As described above, although the resource allocation field has the same value, the redundant bit may indicate a different thing. This is only illustrative, and what the redundant bit indicates may be changed reversely. For the consistency of a description, it is hereinafter assumed that, when the redundant bit is 0, the hybrid resource allocation field indicates contiguous or non-contiguous resource allocation and, when the redundant bit is 1, the hybrid resource allocation field indicates non-contiguous resource allocation.

Meanwhile, although the resource blocks have the same number, the number of cases in which the resource blocks are allocated non-contiguously may be different from the number of cases in which the resource blocks are allocated contiguously. For example, if the number of cases in which n resource blocks are non-contiguously allocated is a and the number of cases in which the n resource blocks are contiguously allocated is b, a>b. The meaning that the number of cases is small means that the number of necessary bits is also small. Contiguous resource allocation can be represented by only two factors: an offset and the length. Accordingly, the number of all the cases of contiguous resource allocation can be represented although contiguous resource allocation has a relatively small number of bits. In contrast, in order to represent the number of all the cases of non-contiguous resource allocation, a relatively large number of bits are necessary.

For example, it is assumed that a BS allocates 100 resource blocks using the hybrid resource allocation field of 13 bits. The 13 bits can represent the total number of 2¹³=8192 cases (or code points).

First, it is assumed that the redundant bit=1 (i.e., the hybrid resource allocation field indicates non-contiguous resource allocation). In the case where 100 resource blocks are allocated according to non-contiguous resource allocation, if there is the number of 19000 cases, the remaining number of 19000−8192=10808 cases can not be represented because the hybrid resource allocation field of 13 bits can represent only the number of 8192 cases. Accordingly, for non-contiguous resource allocation, additional resources capable of represent the 10808 cases are further necessary.

Next, it is assumed that the redundant bit=0 (that is, the hybrid resource allocation field indicates contiguous or non-contiguous resource allocation). In the case where about 100 resource blocks are allocated according to contiguous resource allocation, if there is the number of 5050 cases, the hybrid resource allocation field can represent the number of 5050 cases and can further represent 8191−5050=3141 cases (except the last one code point used for SPS).

For the efficient use of resources, the number of 3141 cases that remain other than the number of all the cases of contiguous resource allocation that may be indicated by the hybrid resource allocation field is used in non-contiguous resource allocation. For example, a range up to 0-5049 in the values of the hybrid resource allocation field corresponds to contiguous resource allocation, and a range up to 5050-8190 in the values of the hybrid resource allocation field corresponds to non-contiguous resource allocation. That is, when a redundant bit is 0, the hybrid resource allocation field may indicate contiguous resource allocation or non-contiguous resource allocation depending on a range of the value of the hybrid resource allocation field.

Additional resources are necessary which can represent the number of 7667 cases other than the remaining number of 3141 cases of the hybrid resource allocation field in the number of 10808 cases additionally necessary for non-contiguous resource allocation.

As describe above, however, to add an additional information bit to the existing uplink grant results in a change of the existing structure. This is not preferred because a load on the blind decoding of a UE is added. Accordingly, if an information bit not used in a special condition, from among bits included in an uplink grant, is used, the structure of the uplink grant can be maintained without change and also limited wireless resources can be efficiently used. A hopping flag included in an uplink grant, together with the hybrid resource allocation field, can be used in order to represent non-contiguous resource allocation.

A principle thereof is described below. In non-contiguous resource allocation, such as Type 0 or Type 1, frequency hopping may not be applied at the time of uplink transmission. In this case, although the hopping flag of an uplink grant indicates the frequency hopping of uplink transmission, the frequency hopping is not applied. For example, if non-contiguous resource allocation is given, a UE performs uplink transmission without frequency hopping irrespective of the indication of a hopping flag included in an uplink grant. That is, in non-contiguous resource allocation, the hopping flag does not have a meaning, but occupies only a space of 1 bit in the uplink grant. Accordingly, the hopping flag is substantially not different from a redundant bit.

Accordingly, the hopping flag may be used to represent non-contiguous resource allocation along with a hybrid resource allocation field when a redundant bit is 1. If a hybrid resource allocation field is 13 bits, there is an advantage in that the hybrid resource allocation field extends up to a total of 14 bits substantially because the hopping flag is 1 bit. Accordingly, there is an advantage in that the number of cases of non-contiguous resource allocation that may be represented is increased to two times. In the above example, there is the number of 2¹⁴=16384 cases by a combination of the hopping flag and the hybrid resource allocation field when the redundant bit is 1. Furthermore, the number of 3141 cases that remains after representing contiguous resource allocation, from among the values of the hybrid resource allocation field when the redundant bit is 0, extends to 3141*2=6282 by the hopping flag of 1 bit. As a result, there is an advantage in that the number of cases that may represent non-contiguous resource allocation extends to 16384+6282=22666.

An information field in which a field used as a first use as described above is adaptively used as a second use (a use to represent non-contiguous resource allocation) in a special situation is called an adaptive field. The hopping flag is an example of the adaptive field.

The hopping flag is used as a use that indicates whether frequency hopping is applied or not at the time of uplink transmission when a hybrid resource allocation field indicates contiguous resource allocation. Furthermore, if a hybrid resource allocation field indicates non-contiguous resource allocation, a hopping flag is used to extend the number of cases that represents non-contiguous resource allocation.

The above example corresponds to an example in which uplink resources are allocated for each resource block. If uplink resources are allocated for each resource block group, the number of cases of non-contiguous resource allocation is further reduced. Accordingly, all the number of cases of non-contiguous resource allocation can be sufficiently represented by an indication range of limited resource allocation.

In the resource allocation method of each type, a DCI format for transmitting new control information may be determined in various ways. For example, the remaining information bits of the existing DCI format may be used for new control information, or a new field may be added to the existing DCI format. For another example, a new DCI format for new control information may be introduced. However, to add a new field to the existing DCI format substantially changes the existing DCI format. This increases the complexity of blind decoding, that is, a process of extracting a DCI format from a PDCCH.

Blind decoding is a decoding method of defining a specific decoding start point in the region of a specific PDCCH, performing decoding on all possible DCI formats in given transmission mode, and distinguishing a user from C-RNTI information masked to CRC. As the number of DCI formats to be decoded, the complexity of blind decoding increases. Furthermore, the meaning that the size of a DCI format is different means that the number of DCI formats to be decoded is increased. In order to reduce a load on the blind decoding of a UE, there is a need for a scheme for maintaining the existing DCI format and also using an unused field or utilizing the existing field.

Assuming that a hybrid resource allocation field is mapped to k information bits a₀ to aₖ₋₁, the hybrid resource allocation field can indicate resource allocation of a total number of 2^{k} cases. Here, a value of the hybrid resource allocation field that indicates each case is called a Resource Indication Value (hereinafter referred to as an RIV) or a code point. For example, if a hybrid resource allocation field is mapped to 10 information bits, a total range of an RIV is an integer of 0˜2¹⁰-1. If a hybrid resource allocation field is 0000000111, an RIV is 8.

The range of an RIV is determined by the number of resource blocks and a resource allocation method. For example, if a BS allocates 100 resource blocks, corresponding to a 20 MHz bandwidth, to a UE according to Type 2, a total number of ₁₀₁C₂=5050 cases are obtained according to Equation 1. Accordingly, an RIV has only to have any value of 0-5049, that is, a first resource range. Here, a minimum number of bits of a hybrid resource allocation field which are necessary to represent all the number of 5050 cases are 13 bits according to Equation 2. However, a maximum RIV that is represented by 13 bits is 2¹³=8192, and thus a total range of the RIV is 0-8191 that is wider than the first indication range. A second indication range that remains other than the first indication range in the total range of the RIV is 5050-8191.

An equation for obtaining the size of the RIV that belongs to the second indication range is equal to Equation 3.

2^{a}−ₙ₊₁C₂−K Equation 3

In Equation 3, a is the number of bits of a resource allocation field, and n is the number of resource blocks corresponding to a given bandwidth. Furthermore, K indicates a range of an RIV that is additionally excluded from the second indication range. For example, if the RIV of 8191 is fixed to and used for SPS, K=1.

The first indication range may be used as an uplink grant, that is, an original use, and the second indication range may be used as another use, for example, to indicate that corresponding DCI regards the transmission of an uplink signal or regards Semi-Persistent Scheduling (SPS). In accordance with this method, there is an advantage in that a new field can be substantially added even without changing a DCI format or adding information about bits to DCI. For example, if an RIV is 5070, a UE can know that corresponding DCI indicates the transmission of an A-SRS because 5070 belongs to the second indication range. For another example, if an RIV is 8191 (i.e., 1111111111111), a UE can know that corresponding DCI is for SPS.

If an RIV corresponding to the second indication range is efficiently utilized, a BS can produce DCI having the same format formally or new DCI substantially by defining a hybrid resource allocation field of DCI as a new field. Or, a DCI field remains intact, but only information indicating that a UE must take a special action may be added. The UE performs blind decoding on the DCI format. As a result of the decoding, the UE determines whether an RIV is the first indication range or the second indication range. If, as a result of the determination, the RIV belongs to the first indication range, the UE can recognize that DCI is DCI having the same method as the existing DCI format. If the RIV belongs to the second indication range, the UE can recognize that DCI is DCI of a new format. Accordingly, the UE does not have a burden of performing blind decoding on the DCI of a new format, and thus resource efficiency can be increased because an RIV of a range that is not used within a resource allocation field to be transmitted is used.

A method of transmitting DCI using an RIV corresponding to the second indication range is described below.

For example, an RIV corresponding to the second indication range may indicate another information not resource allocation. For example, an RIV belonging to the first indication range may indicate the allocation of resource blocks, whereas an RIV belonging to the second indication range may indicate new information on the transmission of an uplink signal by a UE or information on the transmission of a downlink signal to a UE.

For example, if the RIV of a hybrid resource allocation field within DCI is the second indication range, the RIV may indicate that the DCI includes information about the configuration of an A-SRS (hereinafter referred to as ASRS configuration information), information about the configuration of Channel State Information (CSI) transmission, and information about the configuration of ACK/NACK transmission. A UE can recognize that corresponding DCI includes information about ASRS configuration information, information about the configuration of CSI transmission, and information about the configuration of ACK/NACK transmission by determining whether an RIV belongs to the second indication range or not. Or, a BS may transmit information about a downlink signal, for example, a Precoding Matrix Indicator (PMI), a Rand Indicator (RI), or resource allocation information using the second indication range.

The ASRS configuration information includes several fields that are necessary for the transmission of ASRS as in Table 4.

TABLE 4

| | Number of | |
|---|---|---|
| SRS information element | bits | Contents |
| SRS activation | 1 | Analysis of DCI format |
| Transmission bandwidth | 2 | Four SRS bandwidths for each |
| | | operation band |
| Frequency position | 3 or 5 | Bandwidth start position (apply |
| | | 3 bits to a band smaller |
| | | than 5 MHz) |
| Transmission comb | 1 | 2 comb |
| SRS cyclic shift | 3 | 8 cyclic shifts |
| SRS configuration index | 9 | Configuration of subframes |
| I_{SRS} | | allocated for SRS transmission |
| Duration | 0 | One-shot transmission or the |
| | | same duration |
| SRS bandwidth | 0 | One-shot transmission or |
| configuration | | already known by SIB |
| CRC (UE ID) | | UE ID masked to CRC |
| Sum | 35 or 37 | |

Referring to Table 4, the SRS activation field is 1-bit information, and it indicates whether corresponding DCI is a format related to the transmission of ASRS or not. The frequency position field is a parameter that determines the start position of an uplink bandwidth regarding ASRS. The transmission comb field is a parameter to define UpPTS duration that belongs to a special subframe in a TDD system. The SRS configuration index field is a parameter that determines the position of a subframe on which ASRS is transmitted and an offset. The cyclic shift field is a parameter that generates a sequence for the transmission of ASRS. The amount of information of a new field is limited within a range that may be represented by the RIV of the second indication range.

For another example, an RIV corresponding to the second indication range maintains the fields of the existing DCI format without change. Here, DCI may be used to trigger a specific action of a UE. Here, the specific action may correspond to a case where the UE sends an uplink signal to a BS. For example, the specific action may mean that a UE sends an A-SRS or a BS sends a downlink signal to a UE. Accordingly, if, as a result of determination of a UE, the RIV is any one value within the second indication range, the UE can obtain information about resources allocated thereto and also recognize that the UE has to send an A-SRS to a BS. If the fields of the existing DCI format are maintained identically, however, the RIV of the second indication range must be able to indicate information about resource allocation to the UE.

If a bandwidth of 20 MHz is allocated according to Type 2, the entire range of an RIV for allocating 100 resource blocks is 0˜8191, and it can represent the number of 8192 cases. However, the first indication range is 0˜5049, and it indicates the total number of 5050 cases, and the second indication range is 5050˜8191, and it indicates the total number of 3142 cases. The number of cases of the second indication range is smaller than that of the first indication range. That is, the second indication range cannot represent all the number of cases of resource allocation of the first indication range. Accordingly, in order to represent a resource allocation field using the second indication range, the resource blocks are allocated for each resource block group. If the total number of resource blocks is n and the number of resource blocks that form one resource block group is r, the number m of resource block groups may be represented as in Equation 4.

$$m = \frac{n}{r} \qquad Equation 4$$

Accordingly, the number of cases that may be presented when the resource blocks are allocated for each resource block group is represented by Equation 5.

$${}_{n + 1}^{}{C}{}_{2}^{} = \frac{n ( n + 1 )}{2} = \frac{\frac{n}{r} ( \frac{n}{r} + 1 )}{2} \qquad Equation 5$$

For example, in Table 3, if 2 resource blocks are allocated as one resource block group in the 100 resource blocks of a 20 MHz bandwidth, a total of 50 resource block groups are allocated. Accordingly, in accordance with Equation 5, the number of ₅₁C₂=1275 cases can be obtained, which can be included in the second indication range.

For another example, an RIV corresponding to the second indication range may also be used to represent non-contiguous resource allocation. For example, if a hybrid resource allocation field when a redundant bit is 1 is not enough to fully represent non-contiguous resource allocation, a hopping flag, that is, an adaptive field, is additionally used. An insufficient part in this case is used to represent non-contiguous resource allocation up to the second indication range of a hybrid resource allocation field when a redundant bit is 0. In this case, the number of cases for representing non-contiguous resource allocation can be calculated in accordance with Equation 6 below.

V=2^{(x+y)}+z×2^{y} Equation 6

Here, v is an indication range that represents the entire non-contiguous resource allocation, x is the number of bits of a non-contiguous resource allocation field, y is the number of bits of an adaptive field, and z is the second indication range of a contiguous resource allocation field. For example, if x=13 and y=1, v=2¹⁴+3141*2¹=22666. Examples of respective elements that represent non-contiguous resource allocation are listed in Table 5.

TABLE 5

| | Redundant | Hopping | | Total |
|---|---|---|---|---|
| Allocation | bits | flag | Indication range of | number |
| method | (1 bit) | (1 bit) | resource allocation | of RIV |
| Contiguous | 0 | Hopping | 0~5049 | 5050 |
| resource | | or not | | |
| allocation | | (0 or 1) | | |
| Non- | 1 | Include in | 0~16383 | 22666 |
| contiguous | | resource | | |
| resource | | allocation | | |
| allocation | 0 | 0 | 16384~16384 + | |
| | | | 3141-1 | |
| | 0 | 1 | 16384 + | |
| | | | 3141~16384 + | |
| | | | 3141 * 2-1 | |

Referring to Table 5, the indication range can represent not only the contiguous resource allocation state, but also the non-contiguous resource allocation state by a combination of the resource allocation field, the adaptive field, and the redundant bits. Although a combination of {the redundant bits, the hopping flag} is {0, 0, or 1}, the indication range 0˜5049 of resource allocation corresponds to contiguous resource allocation and 5050˜8190 thereof extends twice according to the hopping flag and thus corresponds to non-contiguous resource allocation. Accordingly, even when the redundant bits are 0, the hybrid resource allocation field may indicate contiguous resource allocation or non-contiguous resource allocation depending on a range of the value of the hybrid resource allocation field.

The above example corresponds to a case in which uplink resources are allocated for each resource block. If the uplink resources are allocated for each resource block group, the number of cases of the non-contiguous resource allocation state is further reduced according to calculation, such as Equation 4 and Equation 5. Accordingly, the indication range of limited resource allocation can sufficiently represent all the number of cases of non-contiguous resource allocation.

For yet another example, there is a multi-resource allocation method of applying non-contiguous resource allocation and contiguous resource allocation at the same time. This method is a scheme for reducing the number of cases that represent a resource allocation state. Contiguous resource allocation is applied to a resource block (or the resource block group) at which resource allocation is started or ended, and non-contiguous resource allocation is applied to the others. That is, non-contiguous resource allocation, including a resource block (or a resource block group) having an index of a specific part at which resource allocation is started and a resource block (or a resource block group) having an index of a specific part at which resource allocation is ended, is not applied, and non-contiguous resource allocation is applied to resource blocks (or a resource block group) corresponding to the remaining indices. For example, contiguous resource allocation is applied to a 10% index of a start part and a 10% index of an end part, and non-contiguous resource allocation is applied to only an 80% index of a middle part.

If problems in which it is difficult to satisfy an RF standard when non-contiguous resource allocation is performed at both ends and a form in which a control signal is transmitted at both ends in an LTE standard are taken into account, a multi-resource allocation method is well coincident with a system design aspect.

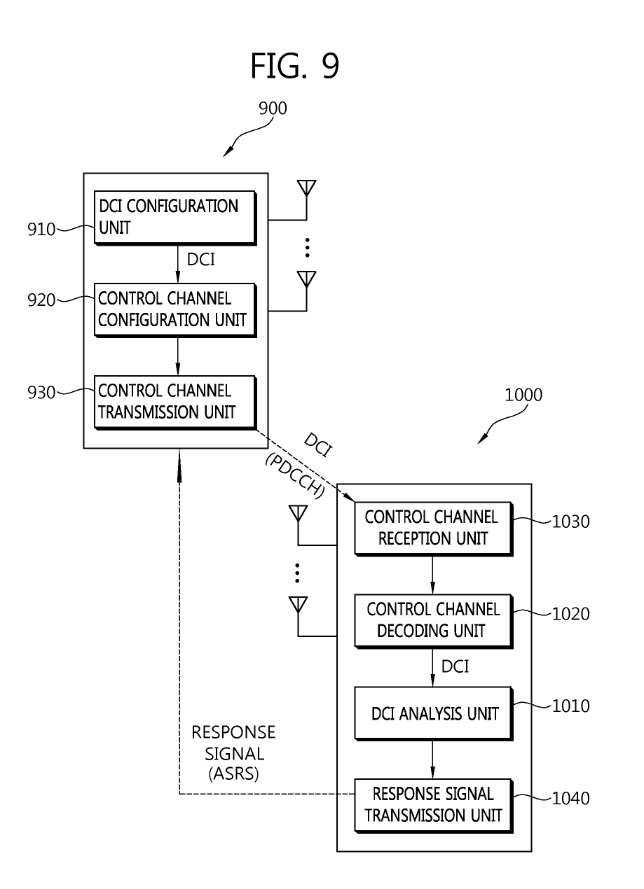

FIG. 9 is a block diagram illustrating a DCI transmission apparatus and a DCI reception apparatus in accordance with an example of the present invention. The DCI transmission apparatus may be part of a BS, and the DCI reception apparatus may be part of a UE.

Referring to FIG. 9, the DCI transmission apparatus 900 includes a DCI configuration unit 910, a control channel configuration unit 920, and a control channel transmission unit 930.

The DCI configuration unit 910 determines a DCI format and configures DCI so that the DCI includes a necessary field. If an uplink grant needs to be transmitted, the DCI configuration unit 910 determines a DCI format as 0. If a downlink grant needs to be transmitted, the DCI configuration unit 910 determines a DCI format as 1A. The DCI configuration unit 910 adjusts an RIV according to the determined DCI format so that the RIV belongs to the second indication range and configures DCI so that the DCI includes a necessary field. Here, when the RIV is R, a range of R is 0≦R≦X. X is a maximum RIV. The first indication range of the RIV is 0≦R<C, and the second indication range is C≦R≦X.

A method of the DCI configuration unit 910 adjusting the RIV so that the RIV belongs to the second indication range is as follows. For example, since DCI of Format 0 is an uplink grant, the DCI configuration unit 910 extracts some region of information bits about the DCI, adds a conversion value C so that the RIV belongs to the second indication range, and inserts a result into the resource allocation field of the uplink grant. For example, the conversion value C is a maximum value of the first indication range and is 5050 based on a 20 MHz bandwidth, Type 2 resource allocation method, the DCI configuration unit 910 adjusts the RIV so that the RIV belongs to the second indication range in such a way as to add 5050 to the RIV so that the RIV becomes 6074 when the RIV is 1024.

The extracted some region may be a region that is partially contiguous to the information bits of the DCI or may have a form in which generally distributed bits are combined. Furthermore, the RIV corresponding to the second indication range can maintain the fields of the existing DCI format without change and may trigger DCI so that a UE takes a special action. The DCI configuration unit 910 configures DCI by combining the extracted some region with the remaining regions so that the DCI has the same size as the uplink grant.

The control channel configuration unit 920 configures a physical channel on which the DCI configured by the DCI configuration unit 910 will be transmitted, that is, a PDCCH.

The control channel transmission unit 930 transmits the DCI to the DCI reception apparatus 1000 through the PDCCH.

The DCI reception apparatus 1000 includes a DCI analysis unit 1010, a control channel decoding unit 1020, a control channel reception unit 1030, and a response signal transmission unit 1040.

The control channel reception unit 1030 receives the DCI from the DCI transmission apparatus 900. The control channel decoding unit 1020 decodes the PDCCH on which the DCI has been carried according to a blind decoding method and extracts the DCI from the PDCCH.

The DCI analysis unit 1010 decomposes a hybrid resource allocation field and other fields from the extracted DCI, determines whether the RIV of the hybrid resource allocation field is greater than or smaller than C, and checks the format and fields of the extracted DCI based on a result of the determination. For example, if, as a result of the determination, the RIV is smaller than C, the DCI analysis unit 1010 checks the format of the extracted DCI as common DCI i.e., an uplink grant. In this case, the response signal transmission unit 1040 transmits uplink data to the DCI transmission apparatus 900 using resources indicated by the uplink grant.

For another example, if, as a result of the determination, the RIV is greater than or equal to C, the DCI analysis unit 1010 checks the format of the extracted DCI as new DCI. Furthermore, the DCI analysis unit 1010 analyzes the fields according to the new DCI format that is configured using fields based on the reminder obtained by subtracting C from the RIV. If the new DCI is for the transmission of ASRS, the DCI analysis unit 1010 instructs the response signal transmission unit 1040 to generate ASRS according to the fields of the new DCI and send the ASRS.

The number of new DCI formats may be one or more the second indication range is divided into several small ranges. Here, C may become several values indicative of the starts of the respective small rages, that is, M values of C₁(=C), C₂, . . . , C_{M}. When the second indication range is divided into several small ranges as described above, the length of information bits regarding a new DCI format corresponding to each of C₁(=C), C₂, . . . , C_{M} is reduced depending on the number of integers within each of the small ranges.

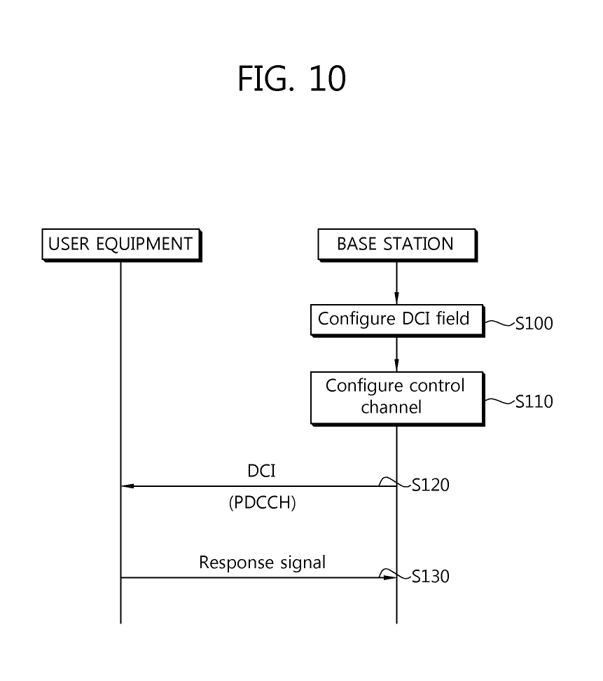

FIG. 10 is a flowchart illustrating a method of transmitting DCI in accordance with an example of the present invention.

Referring to FIG. 10, a BS configures the fields of DCI by adjusting the RIV of the second indication range (S100). A method of the BS configuring the fields of the DCI by adjusting the RIV of the second indication range is as follows. The BS extracts some region of the DCI and adjusts the RIV so that the RIV belongs to the second indication range by adding an integer C value to the RIV. The BS configures the DCI so that the size of a resource allocation region becomes identical with the size of an uplink grant by inserting the adjusted RIV into the resource allocation region of the uplink grant. The DCI may include the fields of Table 2 or Table 4.

The BS configures a control channel through which the DCI will be transmitted (S110). Here, the control channel is a PDCCH. The BS transmits the DCI to a UE through the PDCCH (S120).

The UE receives the DCI by blind decoding, extracts the resource allocation field of the DCI, and checks the format of the DCI using the RIV of the resource allocation field. If the DCI is a new DCI format, the UE processes the new DCI in a method suitable for the new DCI format, performs a procedure required by the new DCI, and transmits a response signal to the BS (S130). For example, if the procedure required by the new DCI is the transmission of ASRS, the UE transmits ASRS to the BS.

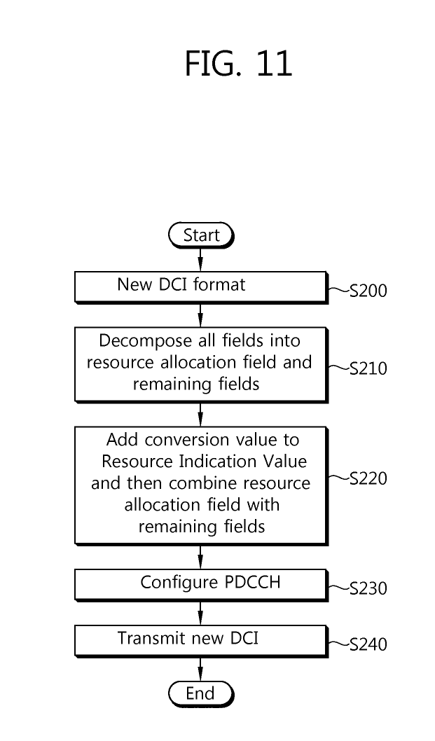

FIG. 11 is a flowchart illustrating a method of a BS transmitting DCI in accordance with an example of the present invention.

Referring to FIG. 11, the BS configures a new DCI format (S200). The new DCI format relates to several pieces of configuration information which are related to the transmission of the uplink control information of a UE. For example, the several pieces of configuration information include ASRS, CSI transmission configuration information, and ACK/NACK information transmission configuration information.

In order to configure the new DCI format, the BS decomposes all the fields of the existing DCI into a resource allocation field and the remaining fields (S210). The RIV of the resource allocation field is Y. The BS calculates a converted RIV X by adding a conversion value C to the RIV and combines the resource allocation field according to the converted RIV X with the remaining fields (S220). This is for the purpose of configuring the new DCI by converting the existing RIV. The BS configures a PDCCH for the new DCI according to the converted RIV (S230) and transmits the new DCI to a UE through the PDCCH (S240).

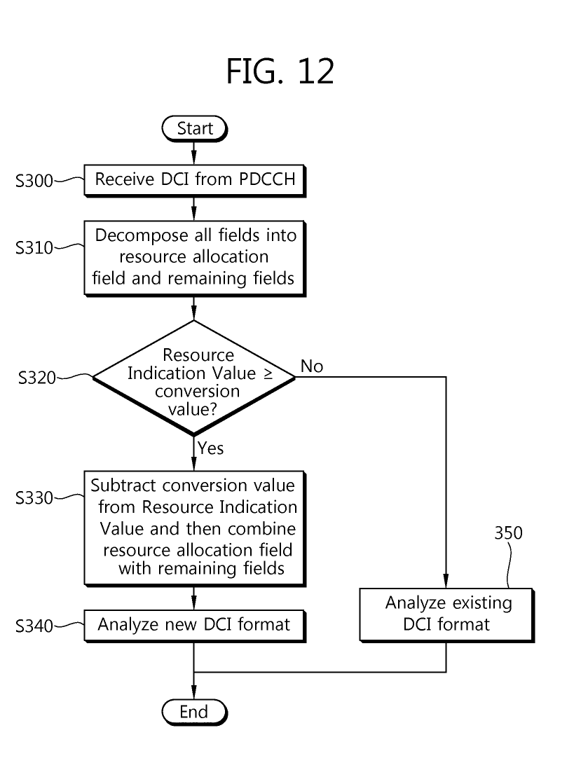

FIG. 12 is a flowchart illustrating a method of a UE receiving DCI in accordance with an example of the present invention.

Referring to FIG. 12, the UE receives DCI by performing blind decoding on a PDCCH (S300). The UE decompose all the fields of the received DCI into a resource allocation field and the remaining fields (S310). The UE compares the RIV X of the resource allocation field with a conversion value C (S320). If, as a result of the comparison, the RIV X is greater than or equal to the conversion value C, the UE calculates a converted RIV Y by subtracting the conversion value C from the RIV X and combines the calculated RIV Y with the remaining fields again (S330). The UE analyzes new DCI according to the calculated RIV Y using a method of analyzing a new DCI format (S340).

If, as a result of the comparison at step S320, the RIV X is smaller than the conversion value C, the UE analyzes all the fields according to the existing DCI format (S350).

The above description is only an example of the technical spirit of the present invention, and those skilled in the art may change and modify the present invention in various ways without departing from the intrinsic characteristic of the present invention. Accordingly, the disclosed embodiments should not be construed as limiting the technical spirit of the present invention, but should be construed as illustrating the technical spirit of the present invention. The scope of the technical spirit of the present invention is not restricted by the embodiments, and the scope of the present invention should be interpreted based on the appended claims. Accordingly, the present invention should be construed as covering all modifications or variations induced from the meaning and scope of the appended claims and their equivalents.

1. A method of a base station sending downlink control information, comprising the steps of:
configuring downlink control information comprising a resource allocation field indicating a Resource Indication Value (RIV) of a specific range; and
transmitting the downlink control information to a user equipment on a physical downlink control channel (PDCCH),
wherein the RIV of the specific range indicates that the downlink control information comprises configuration information for transmitting an uplink signal.

2. The method of claim 1, wherein the uplink signal is a Sounding Reference Signal (SRS) which is used to measure a state of an uplink channel.

3. The method of claim 2, further comprising the step of aperiodically receiving the SRS from the user equipment.

4. The method of claim 1, wherein the RIV of the specific range allocates resource blocks to the user equipment according to at least one of contiguous resource allocation and non-contiguous resource allocation.

5. The method of claim 1, wherein:
the downlink control information further comprises a redundant bit and a hopping flag, and
the resource allocation field indicates non-contiguous resource allocation of resource blocks to the user equipment by being combined with at least one of the redundant bit and the hopping flag.

6. A method of a user equipment receiving downlink control information, comprising the steps of:
receiving downlink control information, comprising a resource allocation field indicative of a Resource Indication Value (RIV) of a specific range, from a base station on a physical downlink control channel (PDCCH);
analyzing a format of the downlink control information based on the RIV of the specific range; and
decoding the downlink control information according to the analyzed format.

7. The method of claim 6, wherein:
the RIV of the specific range indicates that the downlink control information comprises configuration information for a transmission of an uplink signal, and
the uplink signal is a Sounding Reference Signal (SRS) that is a reference signal for measuring a state of an uplink channel.

8. The method of claim 7, further comprising the step of transmitting the SRS to the base station based on the configuration information.

9. The method of claim 6, wherein the RIV of the specific range allocates resource blocks to the user equipment according to at least one of contiguous resource allocation and non-contiguous resource allocation.

10. The method of claim 6, wherein:
the downlink control information further comprises a redundant bit and a hopping flag, and
the resource allocation field indicates non-contiguous resource allocation of resource blocks to the user equipment by being combined with at least one of the redundant bit and the hopping flag.

11. An apparatus for transmitting downlink control information, comprising:
a downlink control information configuration unit for configuring downlink control information based on a Resource Indication Value (RIV) of a specific range that is indicated by a resource allocation field;
a control channel configuration unit for configuring a physical downlink control channel (PDCCH) on which the downlink control information is to be transmitted; and
a control channel transmission unit for transmitting the downlink control information to a user equipment on the PDCCH,
wherein the downlink control information comprises information indicative of a transmission of an uplink signal by the user equipment.

12. The apparatus of claim 11, wherein the uplink signal is a Sounding Reference Signal (SRS) that is a reference signal for measuring a state of an uplink channel.

13. The apparatus of claim 11, wherein the downlink control information configuration unit changes a format of the downlink control information by mapping the resource allocation field to a specific region of an information bit about the downlink control information and adjusting the selected specific range.

14. The apparatus of claim 11, wherein the RIV of the specific range allocates resource blocks to the user equipment according to at least one of contiguous resource allocation and non-contiguous resource allocation.

15. The apparatus of claim 11, wherein the downlink control information configuration unit configures the downlink control information so that a redundant bit and a hopping flag are further included and indicates non-contiguous resource allocation of resource blocks to the user equipment by combining at least one of the redundant bit and the hopping flag with the resource allocation field.

16. An apparatus for receiving downlink control information, comprising:
a control channel reception unit for receiving downlink control information from a base station on a physical downlink control channel (PDCCH);
a control channel decoding unit for extracting the downlink control information by performing blind decoding on the control channel; and
a downlink control information analysis unit for separating a resource allocation field from a plurality of fields included in the downlink control information, checking a format of the downlink control information using a Resource Indication Value (RIV) indicated by the resource allocation field, and analyzing the downlink control information using an analysis method suitable for the checked format.

17. The apparatus of claim 16, wherein:
the RIV of the specific range indicates that the downlink control information comprises configuration information for transmitting an uplink signal, and
the uplink signal is a Sounding Reference Signal (SRS) that is a reference signal for measuring a state of an uplink channel.

18. The apparatus of claim 17, further comprising a response signal transmission unit for transmitting the SRS to the base station based on the configuration information.

19. The apparatus of claim 16, wherein the RIV of the specific range allocates resource blocks to the user equipment according to at least one of contiguous resource allocation and non-contiguous resource allocation.

20. The apparatus of claim 16, wherein:
the downlink control information further comprises a redundant bit and a hopping flag, and
the resource allocation field indicates non-contiguous resource allocation of resource blocks to the user equipment by being combined with at least one of the redundant bit and the hopping flag.
